(19) United States
(12) Patent Application Publication
(10) Pub. No.: US 2010/0005185 A1
(43) Pub. Date: Jan. 7, 2010

(54) SUBSTREAM TRADING IN A PEER TO PEER LIVE STREAMING SYSTEM

(76) Inventors: Zhengye Liu, Brooklyn, NY (US); Shivendra S. Panwar, Freehold, NJ (US); Keith W. Ross, New York, NY (US); Yamming Shen, Brooklyn, NY (US); Yao Wang, Livingston, NJ (US)

Correspondence Address: STRAUB & POKOTYLO, 788 Shrewsbury Avenue, TINTON FALLS, NJ, 07724, US

(21) Appl. No.: 12/490,751

(22) Filed: Jun. 24, 2009

Related U.S. Application Data
(60) Provisional application No. 61/075,248, filed on Jun. 24, 2008.

(51) Int. Cl. G06F 15/16

(52) U.S. Cl. 709/231

(57) ABSTRACT

In a live video P2P system using substream trading, a peer device's video quality is generally commensurate with its upload rate. Such substream trading provides in a P2P live video streaming system provides incentives and can accommodate a variety of video coding schemes. In particular, substream trading with layered video has many desirable properties, including differentiated service, short start-up delays, synergies across peer device types, and protection against free-riders.

### § 0.1 RELATED APPLICATIONS

Benefit is claimed to the filing date of U.S. Provisional Patent Application Ser. No. 61/075,248 (“the '248 provisional”), titled “SUBSTREAM TRADING: TOWARDS AN OPEN P2P LIVE STREAMING SYSTEM,” filed on Jun. 24, 2008 and listing Zhengye LIU, Shivendra S. PANWAR, Keith W. ROSS, Yanming SHEN and Yao WANG as inventors. The '248 provisional is incorporated herein by reference. However, the scope of the claimed invention is not limited by any requirements of any specific embodiments described in the '248 provisional.

### § 0.0 GOVERNMENT RIGHTS

The United States Government may have certain rights in this invention pursuant to a grant awarded by the National Science Foundation. Specifically, the United States Government may have a paid-up license in this invention and the right in limited circumstances to require the patent owner to license others on reasonable terms as provided for by the terms of Agreement No. 0435228 with the National Science Foundation.

### § 1. BACKGROUND OF THE INVENTION

§ 1.1 Field of the Invention

The present invention concerns peer-to-peer (“P2P”) live video streaming.

§ 1.2 Background Information

§ 1.2.1 P2P File Sharing

BitTorrent is a popular file-distribution technology, with millions of users sharing content in hundreds of thousands of torrents on a daily basis. Fundamental to BitTorrent's success is its openness—the BitTorrent protocol is published in the Internet, and the source code of the baseline implementation is made widely available. This openness has enabled developers to create over 50 independent BitTorrent client implementations (See, e.g., the reference, “http://en.wikipedia.org/wiki/bittorrent client.” (incorporated herein by reference).), dozens of independent tracker implementations (See, e.g., the reference, “http://torrentfreak.com/5-most-popular-bittorrent-trackers-070924/.” (incorporated herein by reference).), and a multitude of torrent search sites. The openness of the protocol has further fostered open discussions in both the online developer and research communities, leading to further performance and security improvements. It has also fostered innovations in the broader BitTorrent ecosystem, including recent deployments of distributed trackers, using distributed hash tables (“DHTs”) and gossiping, in many popular BitTorrent clients.

A second key element of BitTorrent's success is its P2P design. Since BitTorrent peer devices assist in file distribution, a file can be distributed to an unlimited number of peer devices with modest initial seeding capacity.

However, with an open P2P design, it becomes important to incorporate an incentive mechanism to encourage peer devices to contribute upload bandwidth. Without such an incentive in an open protocol, clients can easily be written to “free-ride” (that is download without uploading), or be configured to upload at low rates. Bram Cohen, credited with creating the original BitTorrent system, recognized the need of building into the system a simple, but effective incentive mechanism (See, e.g., the reference, B. Cohen, “Incentives Build Robustness in BitTorrent,” in Workshop on Economics of Peer-to-Peer Systems, Berkeley, June 2003 (incorporated herein by reference).). Basically, under BitTorrent's incentive principle, a peer device will get a filefaster if it contributes more upload bandwidth to the torrent. This incentivizes users to upgrade their ISP access and/or increase the maximum upload rates (typically configurable) in their BitTorrent clients. BitTorrent provides this basic incentive using the known “tit-for-tat” algorithm (See, e.g., the reference, B. Cohen, “Incentives Build Robustness in BitTorrent,” in Workshop on Economics of Peer-to-Peer Systems, Berkeley, June 2003 (incorporated herein by reference).), in which peer devices trade blocks of content with each other. Although several recent studies have shown that the tit-for-tat algorithm is insufficient for preventing free-riders or fully incentivizing users (See, e.g., the references, N. Liogkas, R. Nelson, E. Kohler, and L. Zhang, “Exploiting BitTtorrent for Fun (But Not Profit),” in IPTPS, Santa Barbara, February 2006 (incorporated herein by reference); T. Locher, P. Moor, S. Schmid, and R. Wattenhofer, “Free Riding In BitTorrent Is Cheap,” in ACM HotNets 2006, Irvine, November 2006 (incorporated herein by reference); M. Piatek, T. Isdal, T. Anderson, A. Krishnamurthy, and A. Venkataramani, “Do Incentives Build Robustness in BitTorrent?” in NSDI, Cambridge, April 2007 (incorporated herein by reference); and M. Sirivianos, J. H. Park, R. Chen, and X. Yang, “Free-Riding in BitTorrent Networks with the Large View Exploit,” in IPTPS, Bellevue, February 2007 (incorporated herein by reference).), it has nevertheless been very successful in practice. The tit-for-tat algorithm effectively creates a differentiated service (in terms of file transfer speed or rate) at the application layer, providing high-speed uploaders with short download times and low-speed uploaders with high download times.

§ 1.2.2 P2P Live Video Sharing

Recently, several P2P live video systems have been successfully deployed. They have reported phenomenal success on their Web sites, reporting tens of thousands of simultaneous users in a single channel, with stream rates between 300 kbps to 1 Mbps. These systems include CoolStreaming (See, e.g., the reference, X. Zhang, J. Liu, B. Li, and T.-S. P. Yum, “DONet: A Data-Driven Overlay Network for Efficient Live Media Streaming,” in IEEE INFOCOM, Miami, March 2005 (incorporated herein by reference).), PPLive (See, e.g., the references, PPLive, “http://www.pplive.com/.” (incorporated herein by reference); and X. Hei, C. Liang, J. Liang, Y. Liu, and K. W. Ross, “A Measurement Study Of A Large-Scale P2P IPTV System,” in IEEE Trans. on Multimedia, vol. 9, no. 8, December 2007 (incorporated herein by reference).), PPStream (See, e.g., the reference, PPStream, “http://www.ppstream.com/.” (incorporated herein by reference).), WUSee (See, e.g., the references, WUsee, “http://www.uusee.com/.” (incorporated herein by reference); and C. Wu, B. Li, and S. Zhao., “Characterizing Peer-to-Peer Streaming Flows,” in IEEE JSAC, vol. 25, no. 9, December 2007 (incorporated herein by reference).) and many more. The success of these systems shows the potential of broadcasting live video over P2P networks. However, all of these systems are closed and proprietary and the protocols are not published. Consequently, independent client, seed, and tracker implementations are not possible without reverse engineering. Further, there are no forums for discussion and criticism of the various designs, and the companies fully determine what content is distributed over their systems.

Over the past few years, there have been a number of proposals for live P2P video in the research community (See, e.g., the references, X. Zhang, J. Liu, B. Li, and T.-S. P. Yum, “DONet: A Data-Driven Overlay Network for Efficient Live Media Streaming,” in IEEE INFOCOM, Miami, March 2005 (incorporated herein by reference); Y. Chu, S. G. Rao, and H. Zhang, “A Case for End System Multicast,” in ACM SIGMETRICS, Santa Clara, June 2000 (incorporated herein by reference); V. N. Padmanabhan, H. J. Wang, P. A. Chou, and K. Sripanidkulchai, “Distributing Streaming Media Content using Cooperative Networking,” in ACM NOSSDAV, Miami, May 2003 (incorporated herein by reference); M. Castro, P. Druschel, A.-M. Kermarrec, A. Nandi, A. Rowstron, and A. Singh, “SplitStream: High-bandwidth content Distribution in a Cooperative Environment,” in IPTPS, Berkeley, February 2003 (incorporated herein by reference); and V. Venkataraman, P. Francisy, and J. Calandrino, “Chunkyspread: Heterogeneous Unstructured Tree-Based Peer-to-Peer Multicast,” in IEEE ICNP, Santa Barbara, November 2006 (incorporated herein by reference).). None of these papers, however, addresses built-in incentives, or the design of open P2P streaming systems. Within the context of cooperative peer devices, a multiple-description coding (“MDC”)-based multiple-tree scheme that uses a novel taxation scheme to provide differentiated services has been proposed. (See, e.g., the reference, Y.-W. Sung, M. Bishop, and S. Rao, “Enabling Contribution Awareness In an Overlay Broadcasting System,” in ACM SIGCOMM, Pisa, September 2006 (incorporated herein by reference).) However, this proposal assumes cooperative peer devices and therefore does not include built-in incentives. Furthermore, it uses MDC encoding (which is inherently inefficient).

There are three recent proposals on using tit-for-tat incentives in the context of P2P live video streaming. First, in a workshop paper, at least some of the present inventors proposed a tit-for-tat scheme for layered video for chunk-based systems (See, e.g., the reference, “Using Layered Video to Provide Incentives in P2P Streaming,” in ACM SIGCOMM P2P-TV, Kyoto, August 2007 (incorporated herein by reference).). Unfortunately, the present inventors believe that the use of chunks disadvantageously increases playback lag and overhead, and cannot be applied to a variety of coding schemes (most P2P video systems use single layer coding, etc). Second, an MDC-based multiple-tree scheme that employs tit-for-tat incentives has been proposed (See, e.g., the reference, J. D. Mol, D. H. P. Epema, and H. J. Sips, “The Orchard Algorithm: Building Multicast Trees for P2P Video Multicasting Without Free-Riding,” in IEEE Trans. on Multimedia, vol. 9, no. 8, December 2007 (incorporated herein by reference).). In that proposal, each MDC “description” is distributed over a separate tree, and peer devices belonging to different trees exchange descriptions with each other. Unfortunately, this second approach is based on MDC (which is inherently inefficient), cannot be easily adapted to layered video or single-layer video, and restricts a peer device to trade only the description corresponding to the tree to which it belongs. Third, a chunk-based mesh-pull scheme with single-layer video has been proposed (See, e.g., the reference, F. Pianese, D. Perino, J. Keller, and E. W. Biersack, “PULSE: an Adaptive, Incentive-Based, Unstructured P2P Live Streaming System,” in IEEE Trans. on Multimedia, vol. 9, no. 8, December 2007 (incorporated herein by reference).). That scheme applies a combination of tit-for-tat and donation strategies to provide incentives. In particular, peer devices with higher upload contribution have more buffered data and are more robust to peer device dynamics. However, that third scheme is limited to single-layer video and has low throughput.

As can be appreciated from the foregoing, it would be useful to provide a live video system, that is both open and P2P, in which peer devices are incentivized to contribute upload capacity. It would also be useful if such a system could accommodate different video coding schemes (e.g., single-layer coding, layered coding, multiple description coding, etc.).

### § 2. SUMMARY OF THE INVENTION

In embodiments consistent with the present invention, a peer device's video quality is generally commensurate with its upload rate. Thus, peer devices that upload more receive higher quality video. In at least some such embodiments, peer devices that free-ride will receive at best poor quality video, while peer devices that upload at a high average rate can receive maximal quality and peer devices that upload at more modest rates receive moderate quality.

Implicit in this incentive principle is that the system will make available different video qualities. In at least some embodiments consistent with the present invention, different video coding schemes can be used to define video quality with different criteria. At least some embodiments consistent with the present invention can accommodate a variety of coding schemes.

Furthermore, at least some embodiments consistent with the present invention are optimized for performance, providing differentiated service, high throughput, resiliency to churn, and short start-up delays.

At least some embodiments consistent with the present invention provide a live P2P streaming system which allows arbitrary users to seed live video channels (e.g., including live user-generated content). This would allow live content to emanate from handheld wireless devices, and may include diverse sources (e.g., professors' lectures, Little League baseball games, political demonstrations, etc.).

Embodiments consistent with the present invention may use a tit-for-tat mechanism based on substream trading (as opposed to chunk trading). In some exemplary embodiments, peer devices exchange substreams on an even parity basis (e.g., if A gives B exactly n substreams, then B will reciprocate with exactly n substreams). In this way, if peer devices receive more substreams and correspondingly more useful bits, they can obtain a better video quality. Thus, the more substreams a peer device uploads, the more substreams it receives and the better the quality. This is the basic mechanism that incentivizes users to upload more to obtain better video quality of the received video.

However, in some implementations consistent with the present invention, altruistic behavior is permitted (e.g., A can “over-reciprocate” B when A has spare upload capacity). Peer devices can notify, select, request and deliver video in basic content units of substreams (as opposed to chunks). As compared to a chunk-based pull-scheme (as in PPLive), the substream-based approach used in embodiments consistent with the present invention achieves a smaller playback lag with less signaling overhead. However, at least some embodiments consistent with the present invention can use tree-based substream distribution.

In at least some embodiments consistent with the present invention, peer devices self-organize into a mesh as a function of their available bandwidth and content. The mesh overlay (as opposed to tree distribution) is robust and easy to manage in the highly dynamic P2P environment.

With single-layer video, the substreams can be generated by time division of the encoded video. On the other hand, with layered coding or MDC, the substreams are the video layers or descriptions, respectively. Regardless of the coding used, substream trading consistent with the present invention can provide differentiated video quality and a high overall system performance.

### § 3. BRIEF DESCRIPTION OF THE DRAWINGS

FIG. 1 illustrates a mesh-substream P2P live video system consistent with the present invention.

FIG. 2 is a block diagram of an architecture of an exemplary peer device consistent with the present invention.

FIG. 3 is a flow diagram of an exemplary method for providing substream trading in a P2P video delivery system in a manner consistent with the present invention.

FIG. 4 is a diagram illustrating providing substream maps to a peer device in a manner consistent with the present invention.

FIG. 5 is a diagram illustrating providing abstracted substream maps to a peer device in a manner consistent with the present invention.

FIG. 6 is a flow diagram of an exemplary method for selecting substreams (or {substream,partner} pairs) in a manner consistent with the present invention.

FIG. 7 illustrates that substream and partner selection can be thought of as a classical maximum weight matching problem in a bipartite graph.

FIG. 8 is a flow diagram of an exemplary method for providing partner adaptation in a manner consistent with the present invention.

FIG. 9 illustrates a “leaky bucket” state process which may be used in a partner device adaptation scheme consistent with the present invention.

### § 4. DETAILED DESCRIPTION

The present invention may involve novel methods, apparatus, message formats, and/or data structures to facilitate a P2P live video streaming system using substream trading. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

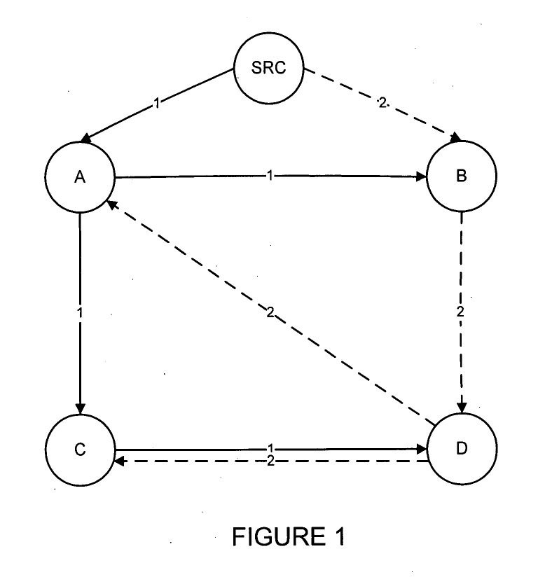

In a substream-based, mesh-pull, P2P video distribution system, the source encodes a video into S substreams, with the rate of each substream denoted by r. The substreams can be generated by time dividing a single-layer video, by layered coding, by MDC, or by some other scheme. Each substream is further divided into chunks of Δ seconds. At any given time, a peer device participating in a torrent will receive a subset of the S substreams from one or more other peer devices in the torrent (including possibly the source). This same peer device will redistribute zero or more of the substreams it receives to other peer devices. In order for a peer device to request substreams from other peer devices, it needs a mechanism for discovering other peer devices in the torrent (a peer device discovery service) and a mechanism for determining which substreams these discovered peer devices have. FIG. 1 shows a simple mesh substream system with one source (SRC), two substreams (1 and 2), and four peer devices (A-D).

Under a substream trading method consistent with the present invention, two partners exchange substreams with each other in a tit-for-tat fashion. In “pure” tit-for-tat substream trading, peer device P sends n substreams to Q if and only if Q sends n different substreams to P. One simple observation is that if all peer devices use “pure” tit-for-tat, then each peer device receives a number of substreams that is exactly equal to the number of substreams it uploads to other peer devices. Consequently, a peer device with higher upload contribution is more likely to trade more substreams and eventually obtain better quality.

Peer device P and peer device Q may trade one or more substreams with each other. If peer device P trades more than one substream, e.g., two substreams, with peer device Q, then for peer device P, peer device Q can be considered to be two “virtual partners”—Q1 and Q2. Peer device P trades only one substream with each of the two virtual partners. For this reason, in the following description, it is assumed that two peer devices (or virtual peers) only trade one substream with each other.

§ 4.1 Exemplary Peer Device Architecture

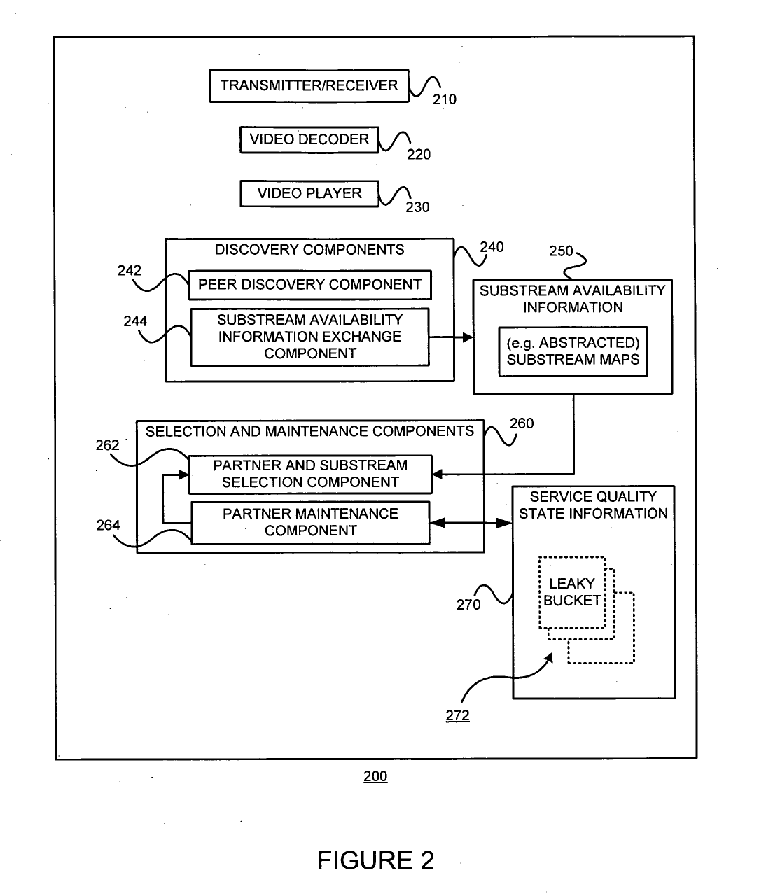

FIG. 2 is a block diagram of an architecture of an exemplary peer device 200 consistent with the present invention. As shown, the exemplary peer device 200 may include a transmitter/receiver 210, a video decoder 220, a video player 230, discovery components 240, stored substream availability information (e.g., (abstracted) substream maps) 250, selection and maintenance components 260 and stored service quality state (e.g., per partner leaky bucket state 272) information 270.

The transmitter/receiver 210 can transmit and receive substreams of video information, as well as other (e.g., control) information. The video decoder 220 can decode one or more substreams of video content. The video player 230 can play the decoded video content.

The discovery components 240 may include a peer discovery component 242 and a substream availability information exchange component 244. The former 242 may be used to discover live video streaming peer devices (e.g., other devices on a network with which the peer device 200 can trade substreams). The later 244 may be used to determine which parts of which substreams of the live video are available on which peer devices. This information (perhaps in abstracted form as described later) may be stored 250.

The selection and maintenance components 260 may include a partner and substream (e.g., {partner,substream} pair) selection component 262 and a partner maintenance component 264. The former 262 may be used to initially select partners from which the peer device is to receive various substreams. This selection may use the stored substream availability information 250. The later 264 may be used to determine when an existing partner (e.g., one that is not uploading as much as promised) should be replaced with a new one. This determination may use service quality state information 270.

At least some embodiments consistent with the present invention may be implemented in hardware (e.g., integrated circuits, application specific integrated circuits, programmable logic or gate arrays, etc.), and/or software (e.g., program instructions stored in memory such as a RAM, ROM, etc., and/or stored on a storage device such as a magnetic or optical disk, etc., executed on a general purpose processor such as a microprocessor). Peer devices may include, for example, mobile telephones, mobile computing devices, net book computers, lap top computers, desktop computers, personal digital assistants, etc. Peer devices may communicate with one another over one or more networks (e.g., wireless networks, LANs, the Internet, etc.).

§ 4.2 Exemplary P2P Substream Trading Method

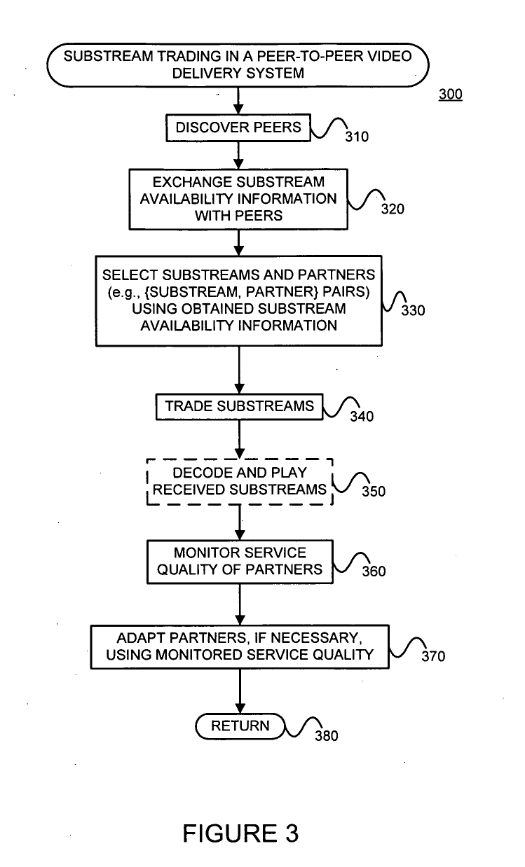

FIG. 3 is a flow diagram of an exemplary method 300 for providing substream trading in a P2P video delivery system in a manner consistent with the present invention. Separate instances of the method 300 may be run by each of a plurality of peer devices. Peer devices are discovered (Block 310) and substream availability information 320 is exchanged with the discovered peer devices (Block 320). Then, substreams and partners (e.g., {substream,partner} pairs) are selected using the obtained substream availability information (Block 330), and the peer device trades substreams with the selected partners (Block 340). Received substreams may be decoded and played. (Block 350) During or after the trading of the substreams, the service quality of the partners may be monitored (Block 370) and the partners may be adapted (dropped, added, etc.) using the monitored service quality (Block 360).

Thus, as can be appreciated from the foregoing, after a newly arriving peer device P obtains a list of other peer devices participating in a torrent from the peer discovery component (242,310) (e.g., by tracker, DHT, gossiping, etc.), it contacts peer devices on the list, searching for partners (e.g., using substream availability information), with whom peer device P establishes overlay links.

Substream availability information may be repeatedly (e.g., periodically, and/or upon the occurrence of a predetermined condition(s)) exchanged. Similarly, substream and partner selection may be repeated (e.g., periodically, and/or upon the occurrence of a predetermined condition(s)). This is because the video content (substreams) uploadable from the peer device devices may change.

§ 4.2.1 Exemplary Peer and Substream Availability Discovery

Referring back to 244 and 320, initially and periodically thereafter, peer device P may request substream availability information (e.g., in the form of substream maps, described below) from its partners periodically, indicating which substreams they currently have. For peer device P, each of its partners may have more than one substream, and each substream may be available on more than one partner.

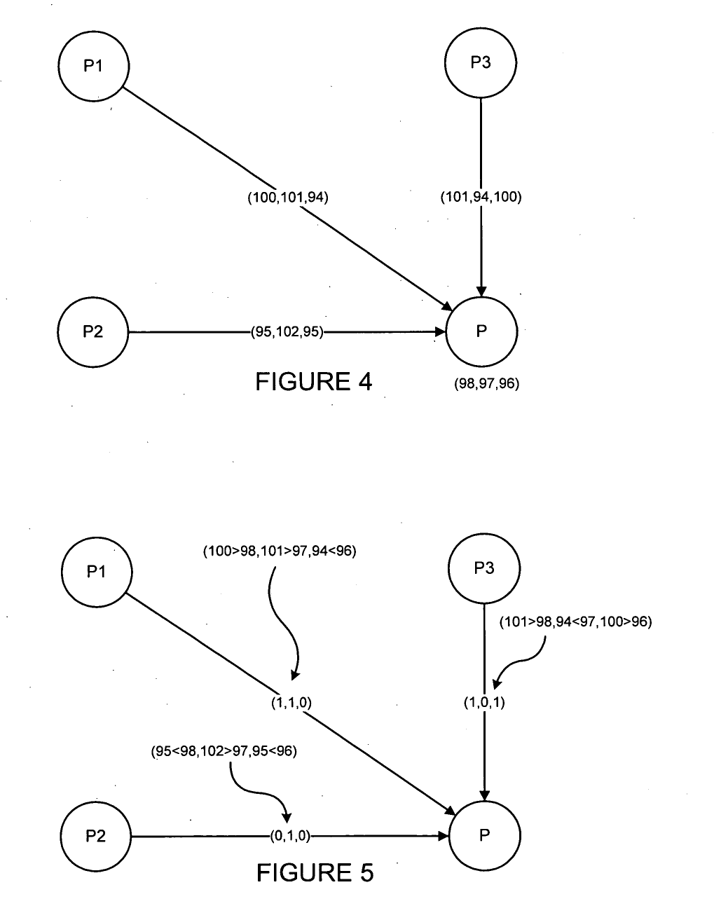

In an exemplary substream trading system consistent with the present invention, a peer device should determine which substreams should be obtained from which partners. In order to do this, the peer device may periodically request substream availability information (e.g., substream maps) from all its partners. FIG. 4 illustrates “substream maps” of peer device P and its partner peer devices P1, P2 and P3. As an example, the substream map of partner peer device P1 indicates that it has three substreams (1,2,3), and the sequence numbers of the last chunks from substreams 1, 2, 3 are 100, 101, 94, respectively. The substream map of partner peer device P2 indicates that it has three substreams (1,2,3), and the sequence numbers of the last chunks from substreams 1, 2, 3 are 95, 102, 95, respectively. The substream map of partner peer device P3 indicates that it has three substreams (1,2,3), and the sequence numbers of the last chunks from substreams 1, 2, 3 are 101, 94, 100, respectively.

Assuming that there is no chunk loss during the transmission (e.g., by using the TCP connections for chunk delivery, and/or by inserting sufficient forward error correction (“FEC”) chunks), the sequence number of the last chunk is sufficient to indicate the chunk availability of a particular substream. Although partner peer device P1 has three substreams available, only substreams 1 and 2 are needed (to be pulled) by peer device P (since peer device P already has more chunks from substream 3 than P1). Similarly, although partner peer device P2 has three substreams available, only substream 2 is needed (to be pulled) by peer device P (since peer device P already has more chunks from substreams 1 and 3 than P2). Similarly, although partner peer device P3 has three substreams available, only substreams 1 and 3 are needed (to be pulled) by peer device P (since peer device P already has more chunks from substream 2 than P2). Thus, the substream maps can be compressed or “abstracted”.

FIG. 5 illustrates “abstracted substream maps” Thus, for example, the abstracted substream map of partner peer device P1 indicates that only substreams 1 and 2 are available (since 100>98, 101>97, but 94<96). Further, the abstracted substream map of partner peer device P2 indicates that only substream 2 is available (since 95<98, 102>97, and 95<96). Finally, the abstracted substream map of partner peer device P3 indicates that only substreams 1 and 3 are available (since 101>98, 94<97, and 100>96). Note that using this substream availability information automatically eliminates possible loops while delivering a substream in a mesh network.

§ 4.2.2 Exemplary Partner and Substream Selection

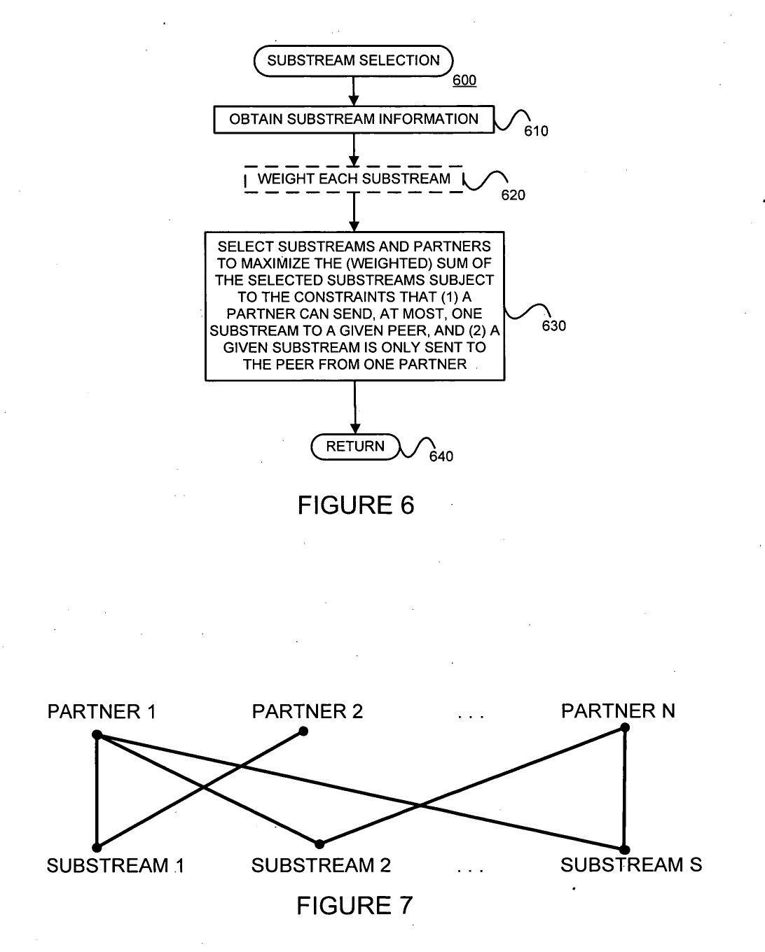

Referring back to 262 and 330, typically, a peer device selects its partners based on some partner selection policy. That is, given the partners and their substream availabilities, peer device P needs to determine which substreams should be obtained from which partners. This may be referred to as a {partner,substream} pair selection. Exemplary partner and substream selection policies are described below with reference to FIG. 6. For example, after having found a sufficient number of partners (on the order of the number of substreams), the peer device P may have exchanged substream availability information with at least some of the partners. It then selects substreams from its partners using the substream availability information. In any event, the selected partners sequentially push the video chunks of their selected substreams to peer device P.

FIG. 6 is a flow diagram of an exemplary method 600 for selecting substreams (or more specifically, {substream,partner} pairs) in a manner consistent with the present invention. The substream information is obtained. (Block 610) If appropriate (depending on the video coding used), each substream may be weighted. (Block 620). Finally, substreams and partners are selected to maximize the sum (or weighted sum if the substreams are weighted) of the selected substreams, subject to two constraints—(1) that a partner can send, at most, one substream to a peer device, and (2) that a given substream is only sent to the peer device from one partner. (Block 630) Recall that each of the peer device and partner devices may be a virtual peer so that a physical peer device and/or partner device may have more than one virtual peer. In such instances, the substream and partner selection considers virtual peers.

Referring to back to block 630, the substream selection problem may be thought of as an optimization problem. More specifically, assume a peer device has N partners (1, . . . , N) from which to request substreams. The set of available substreams in partner n is defined as Sₙ. Let xₛₙ=1 denote that substream s is received from partner n. Since a partner can send at most one substream to a peer (with the “virtual” partner definition), x, is subject to the following constraint:

$${\sum }_{s ∈ {S}_{n}} {x}_{sn} \leq 1 , n = 1 , … , N .$$

Furthermore, since a substream only needs to be sent from one partner, x, is subject to the following constraint as well:

$${\sum }_{n} {x}_{sn} \leq 1 , s = 1 , … , S .$$

Using substream selection, a peer device tries to maximize the received video quality. With different video coding schemes, the importance of each substream could be different. For example, with single-layer coding and MDC, the substreams have equal importance, and the peer device only needs to maximize the number of received substreams (weight=1 for all substreams). On the other hand, with layered coding, since the substreams have unequal importance, the peer device should consider the importance of different substreams in order to maximize the received video quality. To reflect the importance of substreams with layered coding, weights are assigned to each substream, with a larger weight indicating a more important substream. With these weights, the optimal substream selection problem can be converted to maximizing the weighted sum of all substreams as follows:

$$max {\sum }_{s = 1}^{S} {w}_{s} {x}_{sn}$$

subject to:

$${\sum }_{s ∈ {S}_{n}} {x}_{sn} \leq 1 , n = 1 , … , N , and$$

$${\sum }_{n} {x}_{sn} \leq 1 , s = 1 , … , S .$$

where w, denotes the weight of substream s. This is the classical maximum weight matching problem in a bipartite graph as illustrated in FIG. 7, which can be solved with a complexity of O(S³) (See, e.g., the reference, T. H. Cormen, C. E. Leiserson, and R. L. Rivest, Introduction to Algorithm. MIT press, 2000 (incorporated herein by reference).). Examples of appropriate assignments of weights for single-layer video and layered video are described in § 4.3.2 below.

§ 4.2.3 Exemplary Partner Maintenance

Referring back to 264, 360 and 370, from time to time, peer device P may have to drop partners that do not have sufficient upload bandwidth or video content, based on some policy. This may be referred as partnership maintenance. If peer device P drops partners, it may try to find replacement partners from the peer device list.

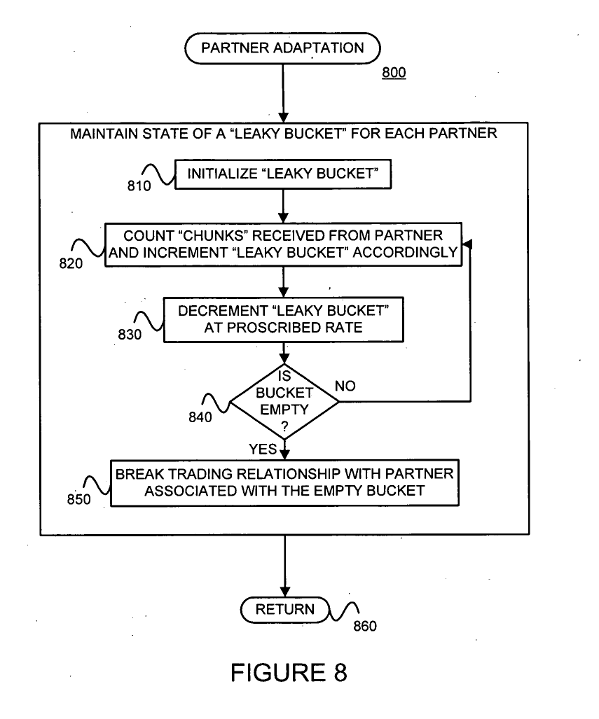

FIG. 8 is a flow diagram of an exemplary method 800 for providing partner adaptation in a manner consistent with the present invention. As shown, a “leaky bucket” state is maintained for each of a peer device's partners. More specifically, leaky bucket state is initialized. (Block 810) Chunks received from the partner peer device are counted and the leaky bucket state is incremented accordingly. (Block 820) Further, the leaky bucket state is decremented at a previously stored rate. (Block 830) If the leaky bucket state does not become “empty”, the method 800 branches back to block 820 and continues as described above. (Condition 840) If, on the other hand, the leaky bucket state becomes “empty”, the substream trading relationship with the partner peer device (associated with the empty leaky bucket) is broken. (Condition 840 and Block 850)

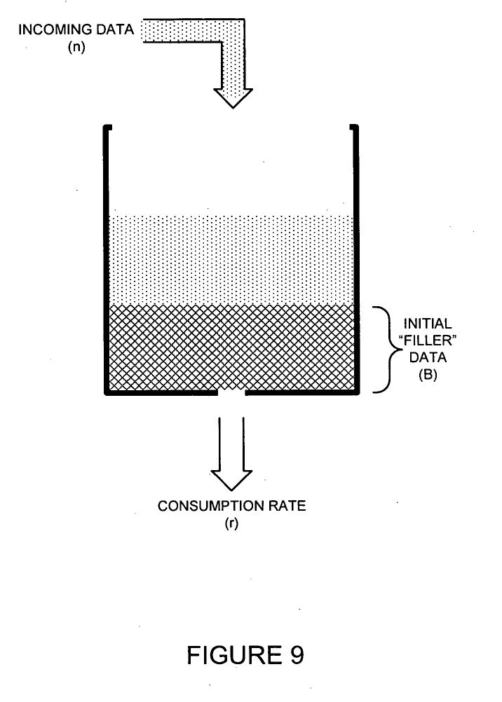

FIG. 9 illustrates the foregoing “leaky bucket” technique which may be used in a partner adaptation scheme consistent with the present invention. More specifically, after two partner devices establish a substream trading relationship, they each monitor the service quality of the other. (Recall block 360 of FIG. 3.) When a peer device cannot (or will not) fulfill its substream trading commitment (e.g., due to lack of substream content, lack of adequate bandwidth, etc.), its partner device will “adapt” this peer partner device (that is, drop it and find a replacement). As just described with reference to FIG. 8 above, a leaky bucket state process may be used by a peer device to monitor the substream trading status of its partner devices. FIG. 9 illustrates a leaky bucket state process for monitoring a partner device's service quality. As shown in FIG. 9, a peer device maintains a leaky bucket for each of its partner devices. The leaky bucket need not actually be used to cache the received chunks of each partner (e.g., partner n). Instead, it may simply count the number of chunks received from partner device n. When the peer device receives a chunk from partner device n, it will fill A bytes into the corresponding bucket. (Recall, e.g., 820 of FIG. 8.) The decrement rate (or consumption rate) of the leaky bucket is set to r. (Recall, e.g., 830 of FIG. 8.) Referring back to 810 of FIG. 8, the leaky bucket may be initialized to include B bytes. Whenever the leaky bucket corresponding to partner device n is empty, the peer device may break the substream trading relationship with its partner n.

The leaky bucket state process can handle Internet jitter, short term content, and/or bandwidth deficiency. Further, a newcomer can get served first and use the received substream to trade other substreams before the leaky bucket empties.

§ 4.3 Refinements, Alternatives and Extensions

§ 4.3.1 Altruistic Peer Devices

A peer device is deemed “altruistic” at any given time if its aggregate upload rate is higher than its aggregate download rate. If altruistic peer devices are present, bandwidth-deficient peer devices can possibly receive video at rates higher than their contributions. However, in at least some embodiments consistent with the present invention, a peer device is not forced to donate bandwidth (i.e., is not forced to be altruistic). In at least some embodiments consistent with the present invention, a bandwidth-rich peer device will only consider donating if it is receiving all substreams (i.e., the full video rate) and still has surplus upload bandwidth.

Assume that a peer device is willing to contribute upload bandwidth C where C/r>S. This peer device can donate C/r-S substreams (that is, it can provide substreams to another peer device or other peer devices without reciprocation).

In at least some embodiments consistent with the present invention, the “benefactor” peer device determines its “beneficiary” peer devices. In one such embodiment consistent with the present invention, an altruistic peer device might select its beneficiaries randomly. In another such embodiment consistent with the present invention, a “biased donation” selection process can also be used. For example, the benefactor peer device might first donate substreams to its existing partners, and then (if there is any remaining bandwidth) other peer devices. Such a “biased donation” selection process helps to combat free-riders.

§ 4.3.2 Video Coding

Substream trading consistent with the present invention can be applied to a variety of different video coding schemes, such as, for example, single-layer video, layered video, MDC, and simulcast. These video coding schemes are addressed in §§ 4.3.2.1 through 4.3.2.4 below.

§ 4.3.2.1 Single-Layer Video

With single-layer video, a video is time-divided into S substreams, each of rate r. If a peer device receives all S substreams, it can reconstruct the video perfectly. Otherwise, the peer device will only be able to reconstruct a corrupted video, or will experience frame freeze and discontinuous video playback.

With substream trading consistent with the present invention, if the upload bandwidth of a peer device is higher than the video rate, it can trade all substreams and obtain a continuous video playback. Otherwise, it can only trade part of substreams and obtain a discontinuous video playback. This difference in video playback quality, commensurate with contributed upload bandwidth of a peer device, provides the basic incentives for peer devices to contribute upload bandwidth.

Note that not all peer devices in a single-layer system are necessarily self-supported, with an upload bandwidth higher than the video rate. If no peer device contributes at a rate higher than the video rate (if there is no altruistic peer device), then the peer devices with low upload bandwidth (less than the video rate) will not receive all S substreams. Although this may discourage such peer devices from participating in substream trading, the present inventors expect there to be some altruistic behavior in P2P live video streaming (See, e.g., the reference, M. Zghaibeh and K. G. Anagnostakis, “On the Impact of P2P Incentive Mechanisms on User Behavior,” in NetEcon+IBC, San Diego, June 2007 (incorporated herein by reference).).

Referring to section 4.2.2 above, with single-layer video, substreams have equal importance. Thus, the weight for each substream for selection can be defined as wₛ=1, where s=1, . . . , S.

§ 4.3.2.2 Layered Video Coding

In recent years, significant advances have been made in layered video coding. Presently, H.264/SVC (layered coding) achieves a rate-distortion performance comparable with H.264/AVC (single-layer coding), with the same visual reproduction quality typically achieved at +/−10% bit rate (See, e.g., the reference, M. Wien, H. Schwarz, and T. Oelbaum, “Performance Analysis of SVC,” in IEEE TCSVT, vol. 17, no. 9, September 2007 (incorporated herein by reference).). It is reported that a real-time system with H.264/SVC encoder and decoder has been successfully implemented (See, e.g., the reference, M. Wien, R. Cazoulat, A. Graffunder, A. Hutter, and P. Amon, “Realtime System for Adaptive Video Streaming Based On SVC,” in IEEE TCSVT, vol. 17, no. 9, September 2007 (incorporated herein by reference).). Thus, thanks to these recent advances, layered coding is a viable candidate for P2P live streaming systems. Furthermore, layered video is a particularly useful concept for P2P, even more so than for client-server. This is because in P2P, layered video responds to heterogeneous upload rates as well as heterogeneous download rates and congestion.

To reiterate, using substream trading consistent with the present invention, a peer device with a higher upload contribution will trade more layers and consequently obtain a better video quality. Furthermore, with layered video, even a small number of layers can lead to passable video quality without discontinuity. Peer devices with low upload bandwidth can therefore be self-sustaining and less dependent on altruistic peer devices.

Referring to section 4.2.2 above, to reflect the layer dependencies, the substream weights used for substream selection can be set to wₛ=2^{S-s}, where s=1, . . . , S. With these weights, a lower layer is more important than the sum of all its upper layers, which is consistent with layered coding.

§ 4.3.2.3 Multiple Description Coding

Like layered video, MDC generates multiple substreams (also referred to as “descriptions”). Unlike layered video, however, each of the substreams is of equal importance. Consequently, video quality is only a function of the total number of substreams received and does not depend on the particular substreams received. Because all substreams have equal importance, designing a P2P live streaming system using MDC (rather than layered video) is more straightforward. A number of recent papers have investigated combining a large number of MDC substreams with P2P to create P2P video streaming systems (See, e.g., the references, V. N. Padmanabhan, H. J. Wang, P. A. Chou, and K. Sripanidkulchai, “Distributing Streaming Media Content using Cooperative Networking,” in ACM NOSSDAV, Miami, May 2003 (incorporated herein by reference); M. Castro, P. Druschel, A.-M. Kermarrec, A. Nandi, A. Rowstron, and A. Singh, “SplitStream: High-bandwidth content Distribution in a Cooperative Environment,” in IPTPS, Berkeley, February 2003 (incorporated herein by reference); Y.-W. Sung, M. Bishop, and S. Rao, “Enabling Contribution Awareness In an Overlay Broadcasting System,” in ACM SIGCOMM, Pisa, September 2006 (incorporated herein by reference); and J. D. Mol, D. H. P. Epema, and H. J. Sips, “The Orchard Algorithm: Building Multicast Trees for P2P Video Multicasting Without Free-Riding,” in IEEE Trans. on Multimedia, vol. 9, no. 8, December 2007 (incorporated herein by reference).). Like layered video, substream trading consistent with the present invention can be applied with MDC. In this case, the weights for each “description” should be equal.

The efficiency of MDC depends on a trade-off between the achievable quality and the number of descriptions used (See, e.g., the reference, Y. Wang, A. R. Reibman, and S. Lin, “Multiple Description Coding for Video Delivery,” in Proceedings of the IEEE, vol. 93, no. 1, January 2005 (incorporated herein by reference).). Unfortunately, MDC is inherently inefficient when a large number of descriptions are created. Among the few proposed methods for generating a large number of descriptions (>4), MD-FEC (See, e.g., the reference, R. Puri and K. Ramchandran, “Multiple Description Source Coding Using Forward Error Correction Codes,” in Asilomar Conference on Signals, Systems and Computers, Pacific Grove, October 1999 (incorporated herein by reference).) together with scalable video coding, and temporal subsampling (See, e.g., the reference, F. H. Fitzek, B. Can, R. Prasad, and M. Katz, “Overhead and Quality Measurements for Multiple Description Coding for Video Services,” in WPMC, September 2004 (incorporated herein by reference).), both introduce significant (>60%) overhead, compared with single-layer video. Thus, although MDC may be used in embodiments consistent with the present invention, its inefficiency may preclude its usage in practical P2P live streaming systems.

§ 4.3.2.4 Simulcast

With simulcast, the video source encodes a video into multiple independent streams, each stream having a different rate, by using single-layer coding. Each stream is then distributed within a separate torrent, with no interaction among the torrents.

Compared to layered video, simulcast requires more source bandwidth. For example, a set of five (5) video simulcast streams, from 200 kbps to 1 Mbps with a 200 kbps step size, would require at least 3 Mbps bandwidth at the source. The corresponding layered design would only require at least 1 Mbps bandwidth. When the sources are residential broadband connections, this becomes a critical issue.

In any event, when the sources have a sufficient upload capacity to support several torrents, substream trading consistent with the present invention can be applied within each torrent, as discussed in the single-layer video system. However, such a design would suffer from lack of sharing across the simulcast streams.

§ 4.3.3 Partner Filtering before Substream Selection

In some embodiments consistent with the present invention, it might be useful to prescreen partners (i.e., filter out partners) before selecting the {substream,partner} pair. Such prescreening (or some other prescreening) might even be applied before substream availability information is exchanged. Such prescreening might be done based on one or more of (1) the upload rate of the partner peer device, (2) the available substreams (if prescreening is applied after substream availability information is exchanged), (3) past performance of the partner peer device, (4) some reputation indication of the partner peer device, etc., for example. Thus, for example, if a partner peer device does not have a sufficient upload bandwidth, the peer device might not even bother exchanging substream availability information with the partner peer device, and/or might not even consider requesting a substream from the partner peer device.

The configured maximum upload rate of peer device P is denoted as bandwidth C, which varies from peer device to peer device. To simplify notation, assume throughout that C is a multiple of r. Thus, the peer device can trade up to T=min(C/r; S) substreams. When a peer device is trading less than T substreams and has spare bandwidth, it may search for additional partners for trading. When peer device P meets another peer device Q that also has spare bandwidth, the two peer devices should decide whether to establish the partnership.

In at least some embodiments consistent with the present invention, a peer device can randomly select peer devices from the active peer devices in the system, and gradually replace unsuitable peer devices by partner adaptation.

To improve the initial selection to reduce such replacement, a peer device can select a partner device from a pre-screened set of candidates. Substream maps of peer devices may be used for the pre-screening. Two peer devices (say P and Q) that intend to establish the partnership, first exchange substream maps with each other. Based on the substream maps, peer device P knows the number of substreams peer device Q currently has, and vice versa. Assume peer device P and peer device Q have s_{P} and s_{Q} substreams, respectively. Without loss of generality, assume s_{P}≧s_{Q}.

In at least some embodiments consistent with the present invention, since peer device P has more content (and potentially has higher upload bandwidth) than peer device Q, peer device Q will accept peer device P as a partner. For peer device P, since peer device Q has less content, it needs to decide whether or not to accept peer device Q as a partner. This is because less content normally indicates lower upload bandwidth of a peer device. At least some embodiments consistent with the present invention may use a simple scheme for peer device P to make such a decision. Specifically, peer device P may agree to form a partnership with probability p_{P}, which is simply given by: p_{P}=(S−s_{P})/S.

Thus, a peer device with fewer substreams available is more likely to accept a partner, even though this partner has less content.

### § 4.4 CONCLUSIONS

As described in the '248 provisional, the present inventors have conducted simulations to evaluate the performance of substream trading consistent with the present invention.

When substream trading was used with single-layer video, unless free-riders were extremely zealous about cheating, they obtained poor-quality video. In an “overloaded system” (in which it is not possible for all peer devices to get acceptable quality), the peer devices that uploaded at rates higher than the video rate received all substreams and had maximal quality. In an “underloaded system” (in which some peer devices had upload capacity lower than the video rate and others had upload capacity higher than the video rate), the system provided maximal quality to all peer devices, provided that the high-capacity peer devices were altruistic.

When substream trading was used with layered video, the video quality that a peer device received was commensurate with its upload rate. Thus peer devices would have an incentive to upload as much as they can. For non-free-riding peer devices, there was little variation in video quality due to fluctuations in the received number of layers. The start-up delay was small, and significantly shorter than the start-up delay of single-layer system. Peer devices in different upload bandwidth categories synergistically shared layers with each other. Finally, aggressive free-riders received the video at a low rate with relatively high quality fluctuations.

Thus, substream trading provides a framework for P2P live video streaming that provides incentives and can accommodate a variety of video coding schemes. In particular, substream trading with layered video has many desirable properties, including differentiated service, short start-up delays, synergies across peer device types, and protection against free-riders.

What is claimed is:

1. A method for facilitating video substream trading in a peer-to-peer video delivery system, the method comprising:
a) discovering, with a first peer device, other peer devices with which the first peer device can exchange information;
b) exchanging, between the first peer device and the other peer devices, video substream availability information;
c) selecting, with the first peer device, from among the other peer devices, partners with which to trade video substreams using video substream availability information received from the other peer devices; and
d) trading, with the first peer device, video substreams with the selected partners.

2. The method of claim 1 wherein the video substream availability information exchanged between the first peer device and the other peer devices includes substream identifiers and, for each identified substream, a sequence number of a last chunk of the identified substream.

3. The method of claim 1 wherein the video substream availability information exchanged between the first peer device and the other peer devices includes substream identifiers and, for each identified substream, an indicator of whether or not a sequence number of a last chunk of the identified substream held by another other peer device is greater than a sequence number of a last chunk of the identified substream held by the first peer device.

4. The method of claim 1 wherein the act of selecting, with the first peer device, from among the other peer devices, partners with which to trade video substreams using video substream information received from the other peer devices includes maximizing a sum of the selected substreams such that a partner peer device will only send, at most, one substream to the first peer, and such that a given substream is only sent to the first peer by one partner.

5. The method of claim 1 wherein the act of selecting, with the first peer device, from among the other peer devices, partners with which to trade video substreams using video substream information received from the other peer devices includes maximizing a weighted sum of the selected substreams such that a partner peer device will only send, at most, one substream to the first peer, and such that a given substream is only sent to the first peer by one partner.

6. The method of claim 1 further comprising:
e) monitoring, with the first peer device, service quality of the selected partners; and
f) adapting, with the first peer device, the selected partners to generate a new set of selected partners when any of the selected partners violates a quality policy.

7. The method of claim 6 wherein the quality policy uses a leaky bucket scheme.

8. The method of claim 7 wherein the leaky bucket scheme uses a leaky bucket process for each of the partner peer devices, wherein each of the leaky buckets is initialized with a first value, the first value is increased in accordance with substream data received from the partner peer device to generate a second value, and wherein the second value is decreased in accordance with a proscribed data rate.

9. Apparatus for facilitating video substream trading in a peer-to-peer video delivery system, the apparatus comprising:
a) means for discovering, with a first peer device, other peer devices with which the first peer device can exchange information;
b) means for exchanging, between the first peer device and the other peer devices, video substream availability information;
c) means for selecting, with the first peer device, from among the other peer devices, partners with which to trade video substreams using video substream availability information received from the other peer devices; and
d) means for trading, with the first peer device, video substreams with the selected partners.

10. The apparatus of claim 9 wherein the video substream availability information exchanged between the first peer device and the other peer devices includes substream identifiers and, for each identified substream, a sequence number of a last chunk of the identified substream.

11. The apparatus of claim 9 wherein the video substream availability information exchanged between the first peer device and the other peer devices includes substream identifiers and, for each identified substream, an indicator of whether or not a sequence number of a last chunk of the identified substream held by another other peer device is greater than a sequence number of a last chunk of the identified substream held by the first peer device.

12. The apparatus of claim 9 wherein the act of selecting, with the first peer device, from among the other peer devices, partners with which to trade video substreams using video substream information received from the other peer devices includes maximizing a sum of the selected substreams such that a partner peer device will only send, at most, one substream to the first peer, and such that a given substream is only sent to the first peer by one partner.

13. The apparatus of claim 9 wherein the act of selecting, with the first peer device, from among the other peer devices, partners with which to trade video substreams using video substream information received from the other peer devices includes maximizing a weighted sum of the selected substreams such that a partner peer device will only send, at most, one substream to the first peer, and such that a given substream is only sent to the first peer by one partner.

14. The apparatus of claim 9 further comprising:
e) means for monitoring, with the first peer device, service quality of the selected partners; and
f) means for adapting, with the first peer device, the selected partners to generate a new set of selected partners when any of the selected partners violates a quality policy.

15. The apparatus of claim 14 wherein the quality policy uses a leaky bucket scheme.

16. The apparatus of claim 15 wherein the leaky bucket scheme uses a leaky bucket process for each of the partner peer devices, wherein each of the leaky buckets is initialized with a first value, the first value is increased in accordance with substream data received from the partner peer device to generate a second value, and wherein the second value is decreased in accordance with a proscribed data rate.
